(19) United States
(12) Patent Application Publication
(10) Pub. No.: US 2021/0022129 A1
(43) Pub. Date: Jan. 21, 2021

(54) METHODS AND APPARATUSES FOR UPLINK CONTROL INFORMATION TRANSMISSION

(71) Applicant: NEC CORPORATION, Tokyo (JP)

(72) Inventors: Fang YUAN, Beijing (CN); Gang WANG, Beijing (CN)

(73) Assignee: NEC CORPORATION, Tokyo (JP)

(21) Appl. No.: 16/969,615

(22) PCT Filed: Feb. 14, 2018
(86) PCT No.: PCT/CN2018/076846

§ 371 Date: Aug. 13, 2020

(51) Int. Cl. H04W 72/04; H04L 1/18

(52) U.S. Cl. CPC H04W 72/0413; H04L 1/1812

(57) ABSTRACT

Embodiments of the present disclosure relate to methods and devices for uplink control information transmission. In example embodiments, a method includes determining, based on a resource indicator from a network device, a resource indicator indicating uplink resources available for transmitting a first type of uplink control information using different formats. The method also includes selecting one of the uplink resources based on a simultaneous transmission indicator from the network device, the simultaneous transmission indicator indicating that simultaneous transmission of the first type and a second type of uplink control information is supported using at least one of the different formats. The method further includes transmitting, to the network device, the first and second types of uplink control information on the selected uplink resource using the corresponding format.

### TECHNICAL FIELD

Embodiments of the present disclosure generally relate to the field of telecommunication, and in particular, to methods and apparatuses for uplink control information (UCI) transmission.

### BACKGROUND

With the development of new radio access (NR) communication technologies, multiple types of services or traffic have been proposed, for example, enhanced mobile broadband (eMBB) generally requiring high data rate, massive machine type communication (mMTC) typically requiring long battery lifetime, and ultra-reliable and low latency communication (URLLC). Various aspects of communications have been changed in the NR communication technologies. Particularly, uplink control information (UCI) transmission has been discussed in the NR specification works.

UCI includes different types of uplink feedback information such as positive or negative acknowledgement (ACK/NACK) to downlink transmission, scheduling requests (SRs), and/or channel state information (CSI) such as periodic CSI (P-CSI) reporting, semi-persistent CSI (SP-CSI) reporting and aperiodic CSI (A-CSI) reporting. The UCI is transmitted by a terminal device such as user equipment (UE) to a network device (for example, gNB). Typically, UCI is transmitted on a physical uplink control channel (PUCCH) resource. The configuration of the PUCCH resource includes a PUCCH format and other parameters defining the resource.

In NR, different PUCCH resource sets may be configured to the terminal device, each including one or more PUCCH resources. The terminal device is allowed to select a PUCCH resource for UCI transmission based on predefined rules and/or downlink control information. Since the terminal device may have different types of UCI to be transmitted and the PUCCH resources available for the UCI transmissions may overlap in time with each other, there is a need to propose a solution for handling PUCCH collision.

### SUMMARY

In general, example embodiments of the present disclosure provide methods and apparatuses for uplink control information (UCI) transmission.

In a first aspect, there is provided a method implemented in a terminal device. The method includes determining, based on a resource indicator from a network device, a resource indicator indicating uplink resources available for transmitting a first type of uplink control information using different formats. The method also includes selecting one of the uplink resources based on a simultaneous transmission indicator from the network device, the simultaneous transmission indicator indicating that simultaneous transmission of the first type and a second type of uplink control information is supported using at least one of the different formats. The method further includes transmitting, to the network device, the first and second types of uplink control information on the selected uplink resource using the corresponding format.

In a second aspect, there is provided a method implemented in a terminal device. The method includes receiving a resource indicator indicating a plurality of uplink resources available for transmitting first uplink control information, the first uplink control information being of a first type. The method also includes determining whether a second uplink resource configured for transmitting second uplink control information and a third uplink resource configured for transmitting third uplink control information overlap in time, the second and third uplink control information being of a second type, and in response to determining that the second and third uplink resources overlap in time, selecting one of the plurality of uplink resources, the selected uplink resource supporting simultaneous transmission of the first and second types of uplink control information. The method further includes transmitting the first, second, and third uplink control information using the selected uplink resource.

In a third aspect, there is provided a method implemented in a terminal device. The method includes determining whether a first uplink resource configured for transmitting first uplink control information and a second uplink resource configured for transmitting second uplink control information overlaps in time. The method also includes in response to determining that the first and second uplink resource overlaps in time, selecting one of the first and second uplink resources based on at least one of capacities of the first and second uplink resources, occasions of the first and second uplink resources, formats supported by the first and second uplink resources. The method further includes transmitting the first and second uplink control information using the selected uplink resource.

In a fourth aspect, there is provided a device. The device includes a processor; and a memory coupled to the processing unit and storing instructions thereon, the instructions, when executed by the processing unit, causing the apparatus to perform the method according to any of the first to the third aspects.

In a fifth aspect, there is provided a computer readable medium having instructions stored thereon, the instructions, when executed on at least one processor, causing the at least one processor to carry out the method according to any of the first to the third aspects.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a block diagram of a communication environment in which embodiments of the present disclosure can be implemented;

FIG. 2 is a flowchart illustrating a process for uplink control information (UCI) transmission according to some embodiments of the present disclosure;

FIG. 3 is a flowchart illustrating a process for UCI transmission according to some other embodiments of the present disclosure;

FIG. 4 is a flowchart illustrating a process for UCI transmission according to some further embodiments of the present disclosure;

FIG. 5 is an illustrative diagram of overlapped PUCCH resources in accordance with some embodiments of the present disclosure;

FIGS. 6A-6D are illustrative diagrams showing UCI transmission on the PUCCH resources in accordance with some embodiments of the present disclosure;

FIGS. 7A-7G are illustrative diagrams showing UCI transmission on the PUCCH resources in accordance with some other embodiments of the present disclosure;

FIGS. 8A-8G are illustrative diagrams showing UCI transmission on the PUCCH resources in accordance with some further embodiments of the present disclosure;

FIG. 9 shows a flowchart of an example method in accordance with some embodiments of the present disclosure;

FIG. 10 shows a flowchart of an example method in accordance with some other embodiments of the present disclosure;

FIG. 11 shows a flowchart of an example method in accordance with some further embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, and the like. For the purpose of discussion, in the following, some embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

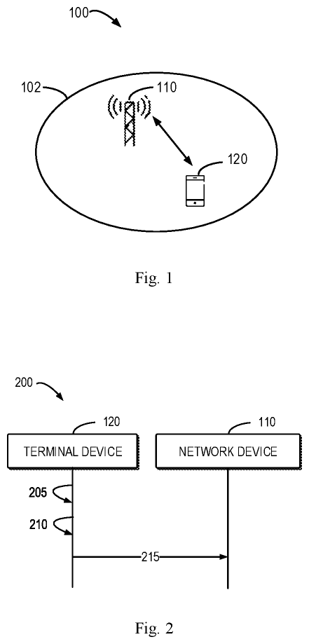

FIG. 1 shows an example communication network 100 in which implementations of the present disclosure can be implemented. The network 100 includes a network device 110 and a terminal device 120 served by the network device 110. The serving area of the network device 110 is called as a cell 102. It is to be understood that the number of network devices and terminal devices is only for the purpose of illustration without suggesting any limitations. The network 100 may include any suitable number of network devices and terminal devices adapted for implementing implementations of the present disclosure. Although not shown, it is to be understood that one or more terminal devices may be located in the cell 102 and served by the network device 110.

In the communication network 100, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

Communication discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In communications, the terminal device 120 may transmit uplink control information (UCI) to the network device 110. UCI may include different types of control information. In an example, the terminal device 120 may request uplink resources for uplink data transmission by transmitting a scheduling request (SR) to the network device 110, and in this case, the SR is a type of UCI. In another example, ACK/NACK transmission provides feedback information from the terminal device 120 to the network device 110 regarding whether a transmitted downlink transport block on the physical downlink shared channel (PDSCH) is successfully received or not. The ACK/NACK feedback may be transmitted in a hybrid automatic repeat request (HARQ) process and thus may be referred to HARQ ACK/NACK The ACK/NACK feedback information may be another type of UCI. In a further example, the terminal device 120 may also transmit channel state information (CSI) to the network device 110 to report information on a channel between the terminal device 120 and the network device 110. The CSI feedback may include channel quality indicator (CQI), rank indicator (RI), channel resource indicator (CRI), precoding matrix indicator (PMI), reference signal receiving power (RSRP), strongest layer indicator (SLI), and/or any other channel state-related information.

Typically, UCI is transmitted on a physical uplink control channel (PUCCH) resource. PUCCH resources may be configured with different formats, each of the formats being defined with parameters related to the corresponding PUCCH resource. Such parameters include, but are not limited to, one or more of the following: the starting location of the PUCCH resource, the length of the PUCCH resource (the number of symbols, the number of physical resource blocks (PRBs)), frequency hopping, cyclic shifts, the index and/or length for orthogonal cover code, the spatial setting, and/or the like. Currently, there are five different formats specified in the NR specifications, including PUCCH format 0 to PUCCH format 4 as listed in Table 1 where the length of OFDM symbols and the number of bits of different PUCCH formats are provided. It would be appreciated that Table 1 is provided for purpose of illustration only.

TABLE 1
An example of PUCCH formats

| PUCCH format | Length in OFDM symbols | Number of bits |
|---|---|---|
| 0 | 1-2 | ≤2 |
| 1 | 4-14 | ≤2 |
| 2 | 1-2 | >2 |
| 3 | 4-14 | >2 |
| 4 | 4-14 | >2 |

The terminal device 120 may be configured with a number of sets of PUCCH resources by the network device 110, each including a plurality of PUCCH resources. For example, the number of sets of PUCCH resources may be configured by higher layer parameters, indicating the number of PUCCH resources and the location of PUCCH resources included in each set of PUCCH resources.

To transmit different types of UCI, PUCCH resources with different formats may be determined from the configured sets of PUCCH resources by the terminal device according to signaling from the network device. For example, to transmit the HARQ ACK/NACK feedback, PUCCH resources of PUCCH formats 0 to 4 may be used. To transmit CSI reports, PUCCH resource of PUCCH formats 2 to 4 may be used. To transmit SRs, PUCCH resource of PUCCH formats 0 to 1 may be used.

The terminal device may have ACK/NACK feedback, CSI, and SR to be transmitted in a time slot. In addition, it has been agreed that the terminal device may be configured with more than one PUCCH resource to transmit a plurality of CSI reports in one time slot. Generally, resources for ACK/NACK feedback, CSI, and SR are configured and selected independently. Therefore, PUCCH resources configured for transmitting the different types of UCI may be overlapped with one another fully or partially.

There have been proposed some solutions for handling PUCCH collision. According to a solution, in case of PUCCH resources for two or more CSI reports overlapped with one another, the CSI reports with the highest priorities may be carried in a multi-CSI PUCCH resource and the remaining CSI reports are discarded or dropped. However, this solution can only be applied when the terminal device has CSI reports to be transmitted only (without other types of UCI). In some solutions, when PUCCH resources for transmitting ACK/NACK feedback, SR, and CSI overlap with each other, since the transmission priority of the ACK/NACK feedback is higher, the CSI and/or SR will be dropped and the ACK/NACK feedback may then be transmitted on the configured PUCCH resource.

According to some solutions, when PUCCH resources for transmitting the ACK/NACK feedback, SR, and CSI overlap in time with each other, the terminal device is allowed to determine a set of PUCCH resources from a plurality of preconfigured sets of PUCCH resources based on a payload size of all the UCI (including ACK/NACK feedback, SR, and CSI), and then select a PUCCH resource from the set of PUCCH resources based on downlink control information (UCI) which is used to determine the resource for the case of ACK/NACK transmission only. However, the selected PUCCH resource may not be configured with a format that supports simultaneous transmission of the ACK/NACK, SR and CSI. In this case, the CSI and/or SR may also be dropped.

There has been proposed a solution to handle the PUCCH collision of the ACK/NACK feedback and SR. Particularly, since the SR will consume a few bits (1 or 2 bits), when the collision happens, the SR can be multiplexed with the ACK/NACK feedback and transmitted using the PUCCH resource configured for the ACK/NACK feedback. It has been agreed in the NR that one or more bits can be appended to the end of the ACK/NACK feedback to indicate one or more SRs from the terminal device.

Although there have been proposed some solutions for handling PUCCH collision, the SR and CSI are still discarded with a high probability, which will affect the efficiency and/or performance of the UCI transmission. There is a need to propose a solution for UCI transmission so as to handle the PUCCH collision in a more efficient and effective manner and to reduce the change of dropping CSI.

Principle and implementations of the present disclosure will be described in detail below with reference to FIG. 2, which shows a process 200 for UCI transmission according to an implementation of the present disclosure. For the purpose of discussion, the process 200 will be described with reference to FIG. 1. The process 200 may involve the network device 110 and the terminal device 120 in FIG. 1.

The terminal device 120 determines (205), based on a resource indicator from the network device 110, uplink resources available for transmitting a first type of UCI. The resource indicator is transmitted by the network device 110 to indicate one or more uplink resources for transmitting the first type of UCI. In some embodiments, the first type of UCI includes an ACK/NACK feedback and thus the resource indicator may be referred to as ACK/NACK resource indicator (ARI for short). In some other embodiments, the first type of UCI may additionally or alternatively include one or more SRs. For convenience of discussion, the ACK/NACK feedback will be described as an example in below detailed description. The resource indicator may be transmitted from the network device 110 as downlink control information (DCI).

Typically, in some communication systems such as those based on the NR techniques, the terminal device 120 may be configured with a plurality sets of PUCCH resources, each set including a plurality of PUCCH resources for uplink transmission of UCI. Each of the uplink resources is defined by a corresponding format (also referred to as a PUCCH format) which specifies the starting location of the PUCCH resource, the length of the PUCCH resource (the number of symbols, the number of physical resource blocks (PRBs)), frequency hopping, cyclic shifts, the index and/or length for orthogonal cover code, the spatial setting, and/or the like. The resource indicator may indicate a PUCCH resource included in each of the plurality sets of PUCCH resources. An example of the mapping relationship between the PUCCH resources in the sets and different resource indicators is provided in below Table 2. It would be appreciated that Table 2 is provided for purpose of illustration only.

TABLE 2
Mapping relationship between
the PUCCH resources and resource indicators

| | PUCCH set 1 | PUCCH set 2 | PUCCH set 3 | PUCCH set 4 |
|---|---|---|---|---|
| ARI0 | PF0 | PF2A (short, | PF2B (short, | PF2C (short, |
| | | RBs = 2) | RBs = 4) | RBs = 8) |
| ARI1 | PF1A | PF2B (short, | PF3A (long, | PF3B (long, |
| | | RBs = 2) | RBs = 2) | RBs = 16) |
| ARI2 | PF1B | PF4A (long, | PF4B (long, | PF4C (long, |
| | | slots = 4) | slots = 8) | slots = 14) |

In Table 2, PFO represents a PUCCH resource associated with a format 0, PF1A represents a PUCCH resource associated with a format 1, PF1B represents another PUCCH resource associated with a format 1, and so on and so forth. In addition, PF2A (short, RBs=2) represents a short PUCCH resource having two resource blocks with a format 2, PF4A (long, slots=4) represents a short PUCCH resource having four slots with a format 4, and so on and so forth.

Upon receiving the resource indicator from the network device 110, the terminal device 120 determines the uplink resources available for uplink transmission of the first type of uplink control information using the corresponding formats. For example, if the terminal device 130 receives a resource indicator of ARI1, the terminal device 130 may determine that PUCCH resources of PF1A, PF2B, PF3A, and PF3B are available for transmitting ACK/NACK feedback. These PUCCH resources can be used for uplink transmission using the corresponding format 1, format 2, and format 3.

The terminal device 120 selects (210) one of the uplink resources based on a simultaneous transmission indicator which indicates that simultaneous transmission of the first type and a second type of UCI is supported using one or more corresponding formats. Then the terminal device 120 transmits (215) the first and second types of UCI on the selected uplink resource using the corresponding format. Generally, if the terminal device 120 determines that the first and second types of UCI is to be transmitted in the same time slot, and the configured PUCCH resources for the first and second types of UCI overlap with each other in time, the terminal device 120 may need to select a PUCCH resource for simultaneous transmissions of the first and second types of UCI. In embodiments of the present disclosure, the PUCCH resource may be selected from the PUCCH resources available for transmitting the first type of UCI (the ACK/NACK feedback).

The simultaneous transmission indicator is transmitted from the network device 110 and is configured for the terminal device 120 on the basis of PUCCH format. A simultaneous transmission indicator may be referred to as PUCCH-Fx-simultaneous-HARQ-ACK-CSI, where x represents the corresponding PUCCH format index (x=2,3,4). Upon receiving the simultaneous transmission indicator, the terminal device 120 determines that PUCCH resources in the sets associated with the corresponding format(s) indicated by the simultaneous transmission indicator can be used to transmit different types of UCI (the first and second types) simultaneously. The second type of UCI may be CSI. For example, if the terminal device 120 receives a first indicator of PUCCH-F2-simultaneous-HARQ-ACK-CSI indicating that simultaneous transmissions of ACK/NACK feedback and CSI is supported by the PUCCH format 2 and a second indicator of PUCCH-F3-simultaneous-HARQ-ACK-CSI indicating that simultaneous transmissions of ACK/NACK feedback and CSI is supported by the PUCCH format 3, the terminal device 120 may determine that all the PUCCH resources associated with PUCCH formats 2 and 3 can be used for simultaneous transmission of the ACK/NACK feedback and CSI.

By selecting based on the simultaneous transmission indicator, the terminal device 120 is able to select a PUCCH resource that is associated with a PUCCH format supporting simultaneous transmission of both the first and second types of UCI. Thus, both the ACK/NACK feedback and the CSI can be simultaneously transmitted in the current time slot. For example, if the simultaneous transmission indicators of PUCCH-F2-simultaneous-HARQ-ACK-CSI and PUCCH-F3-simultaneous-HARQ-ACK-CSI are received, the terminal device 120 may determine that the PUCCH resources of PF2B, PF3A, and PF3B are available for simultaneous transmissions of the ACK/NACK feedback and CSI. In this case, the terminal device 120 may select any one of PF2B, PF3A, and PF3B for transmitting the ACK/NACK feedback and CSI.

According to embodiments of the present disclosure, by determining the PUCCH resources in different PUCCH sets first and then selecting the PUCCH resource from the determined PUCCH resource based on the simultaneous transmission indicator, it is ensured that the selected PUCCH resource can be used for simultaneous transmission of the ACK/NACK feedback and CSI. Thus, the CSI will be dropped rarely in the case of PUCCH collision.

In some embodiments, the terminal device 120 may select the uplink resource based on additional factors when there are multiple uplink resources indicated by the received resource indicator being configured a simultaneous transmission indicator. In one embodiment, the terminal device 120 may select the uplink resource based on a total payload size of the first and second types of UCI. Different uplink resources may support different sizes of payload. It is expected to select a resource that is able to convey as much payload as possible for the first and second types of UCI based on predetermined UCI priority rules. By selecting the PUCCH resource based on the total payload size, it is possible to reduce the dropping chance of the UCI.

In some examples, if the terminal device 120 have one or more SRs to be transmitted in addition to the ACK/NACK feedback and CSI, the total payload sizes may be calculated based on the SR(s), the ACK/NACK feedback and CSI. In this case, the simultaneous transmission of the SR(s) and ACK/NACK feedback may be solved by some existing solutions, but the simultaneous transmission of the ACK/NACK feedback and CSI can be supported according to the embodiments as discussed above with respect to FIG. 2. In some embodiments, the PUCCH resource supporting a payload size that is greater than or equal to the total payload size can be selected. In some other embodiments, the PUCCH resource supporting the greatest payload size can be selected.

In a further embodiment, the terminal device 120 may select the uplink resource for transmitting the first and second types of UCI based on a coverage requirement and/or a latency requirement for at least one of the first and second types of uplink control information. The ACK/NACK feedback and/or the CSI may have corresponding requirements for the coverage and latency. Since the PUCCH resources are associated with different PUCCH formats each defined by corresponding resource locations, frequency hopping, and/or cover codes, uplink transmission on different PUCCH resources can achieve different coverage levels and/or latency requirements. For example, the PUCCH resource of PF2B may be selected since this resource can support a larger latency or coverage.

In some embodiments, the terminal device 120 may select the uplink resource further based on predetermine priorities of PUCCH formats. All the PUCCH formats may be configured with corresponding priorities. In some cases, the terminal device 120 may receive more than one simultaneous transmission indicator indicating that the simultaneous transmission is supported using two or more different PUCCH formats. Thus, the terminal device 120 may select the uplink resource that is associated with the PUCCH format having the highest priority from among the two or more different PUCCH formats. For example, a long PUCCH format (3/4) may have a higher priority than a short PUCCH format (2), and vice versa.

Since the PUCCH formats can define the parameters associated with the corresponding PUCCH resources, different PUCCH formats may be associated with different capacity, latency, and/or coverage requirements. By prioritizing the PUCCH formats for example based on the different capacity, latency, and/or coverage requirements, it is also possible to select the PUCCH resource that supports uplink transmission with a larger capacity, a better coverage level or a lower latency.

In some embodiments, for each resource indicator, the network device 110 may transmit a simultaneous transmission indicator indicating that the simultaneous transmission is supported using one PUCCH format. Thus, the simultaneous transmission indicator is configured per resource indicator. In this case, the received simultaneous transmission indicator transmitted from the network device 110 to the terminal device 120 may indicate that the simultaneous transmission is supported using only one PUCCH format among the formats associated with the PUCCH resource available for transmitting the first type of UCI. Thus, based on the simultaneous transmission indicator, the terminal device 120 may select only one PUCCH resource from the available PUCCH resource for the simultaneous transmission.

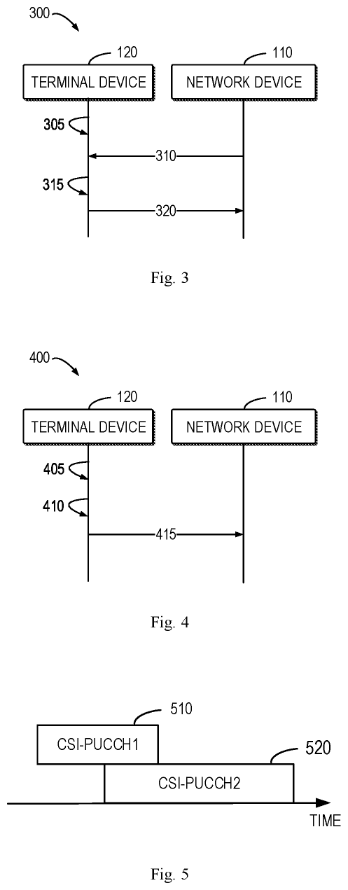

In some cases, the terminal device 120 may have a ACK/NACK feedback and a plurality of CSI reports to be transmitted in the same slot. The configured PUCCH resources for the ACK/NACK feedback and multiple CSI reports may overlap with each other in time. Some embodiments of the present disclosure are provided to handle the collision of ACK/NACK feedback and multiple CSI reports. FIG. 3 illustrates a process 300 of UCI transmission according to these embodiments. For the purpose of discussion, the process 300 will be described with reference to FIG. 1. The process 300 may involve the network device 110 and the terminal device 120 in FIG. 1.

The network device 110 transmits (305) to the terminal device 120 a resource indicator indicating a plurality of uplink resources for transmitting first uplink control information of a first type. In these embodiments, the first type of UCI may be the ACK/NACK feedback. Upon receiving the resource indicator, the terminal device 120 determines the uplink resource available for the ACK/NACK feedback.

As mentioned above, the terminal device 120 may be configured with a plurality sets of PUCCH resources, each set including a plurality of PUCCH resources for uplink transmission of UCI. A resource indicator may indicate a PUCCH resource included in each of the plurality sets of PUCCH resources. An example of the mapping relationship between the PUCCH resources in the sets and different resource indicators is provided in below Table 3. It would be appreciated that Table 3 is provided for purpose of illustration only.

TABLE 3
Mapping relationship between the PUCCH
resources and resource indicators

| | PUCCH set 1 | PUCCH set 2 | PUCCH set 3 | PUCCH set 4 |
|---|---|---|---|---|
| ARI0 | PF0 | PF2B | PF4 | PF3 |
| ARI1 | PF1A | PF2C | PF2D | PF2E |
| ARI2 | PF1B | PF2F | PF4B | PF3A |
| ARI3 | PF1C | PF2G | | |

In Table 3, PFO represents a PUCCH resource with a format 0, PF1A represents a PUCCH resource with a format 1, PF1B represents another PUCCH resource with a format 1, and so on and so forth.

The terminal device 120 determines (310) whether a second uplink resource configured for transmitting second uplink control information and a third uplink resource configured for transmitting third uplink control information overlaps in time, the second and third uplink control information being of a second type. In these embodiments, the terminal device 120 may transmit two or more CSI reports to the network device 110 as UCI and thus the second type of UCI may be CSI. PUCCH resources can be configured as the uplink resources for UCI transmission. The PUCCH resources for transmission of CSI reports may be configured by the network device 110 via higher layer signaling such as radio resource control (RRC) signaling.

If the terminal device 120 determines that the second and third uplink resource overlaps in time, the terminal device 120 selects (315) one of the plurality of uplink resources and transmits (320) the first, second, and third UCI to the network device 110 using the selected uplink resource. In these embodiments, if the uplink resources for transmitting the CSI reports overlap in time, the terminal device 120 may select the PUCCH resource of the ACK/NACK feedback and use the selected PUCCH resource for transmitting the CSI reports. Since the PUCCH resource can be used to transmit the plurality of CSI reports and the ACK/NACK feedback, it can also be called as an ACK/NACK-and-multi-CSI PUCCH resource.

To enable simultaneously transmit the ACK/NACK feedback and the CSI reports, the selected PUCCH resource may support simultaneous transmission of the ACK/NACK feedback and the CSI reports. The simultaneous transmission can be supported according to the PUCCH format associated with the PUCCH resource, as discussed above. The terminal device 120 may receive a simultaneous transmission indicator indicating that the simultaneous transmission of the ACK/NACK feedback and the CSI reports is supported by a PUCCH resource. If the ACK/NACK-and-multi-CSI PUCCH resource is included in the plurality of PUCCH resource indicated by the resource indicator, the terminal device 120 may select this resource.

In some embodiments, the PUCCH resources for simultaneous transmission of the ACK/NACK feedback and CSI reports can be configured per resource indicator. In this case, from among the PUCCH resources indicated by the received resource indicator, one PUCCH resource can be configured as the ACK/NACK-and-multi-CSI PUCCH resource and thus can be selected for the simultaneous transmission. Such PUCCH resource is ensured to be associated with a PUCCH format that supports the simultaneous transmission.

In the above cases, the PUCCH collision of multiple CSI reporting is solved based on the resource indicator which is transmitted in downlink control information. Some other embodiments of the present disclosure provide a further solution for multi-CSI related collision. FIG. 4 illustrates a process 400 of UCI transmission according to these embodiments. For the purpose of discussion, the process 400 will be described with reference to FIG. 1. The process 400 may involve the network device 110 and the terminal device 120 in FIG. 1.

The terminal device 120 determines (405) whether a first uplink resource configured for transmitting first UCI and a second uplink resource configured for transmitting second UCI overlaps in time. The first and second UCI have the same type. In these embodiments, the terminal device 120 may transmit two or more CSI reports to the network device 110 as UCI and thus the first and second UCI may be different CSI reports. Each CSI report is configured with a PUCCH resource for UCI transmission. The PUCCH resources for transmission of CSI reports may be configured by the network device 110 via higher layer signaling such as radio resource control (RRC) signaling.

If the terminal device 120 determines that the first and second uplink resource overlaps in time, the terminal device 120 selects (410) one of the first and second uplink resources and transmits (415) the first and second UCI using the selected uplink resource. FIG. 5A shows an example of overlapped PUCCH resources for CSI reports. As shown, a first PUCCH resource 510 for transmitting a first CSI report (referred to as CSI-PUCCH1) and a second PUCCH resource 520 for transmitting a second CSI report (referred to as CSI-PUCCH2) overlap partially in time. It would be appreciated that the PUCCH resources for different CSI reports may also overlap fully with each other in time. In these embodiments, without the resource indicator, the collision of multiple CSI reports can be handled at the RRC level (since the PUCCH resources for CSI transmission are configured via RRC signaling).

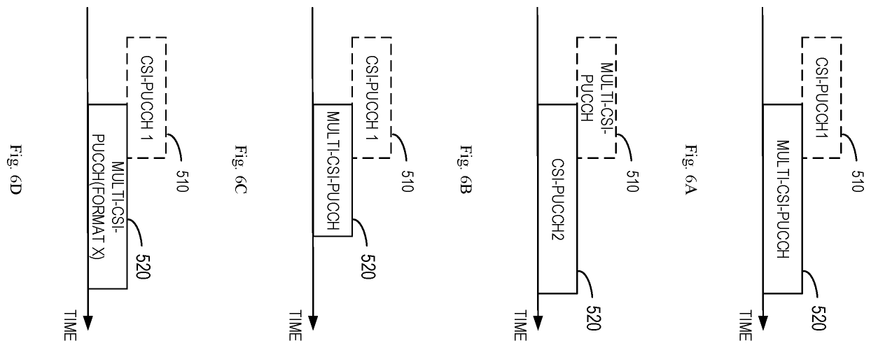

The terminal device 120 selects the uplink resource based on at least one of capacities of the first and second uplink resources, occasions of the first and second uplink resources, formats supported by the first and second uplink resources. FIGS. 6A-6D show some examples of selecting the PUCCH resource from the overlapped PUCCH resources of FIG. 5.

In the embodiment as shown in FIG. 6A, the terminal device 120 selects one of the PUCCH resources 510 and 520 based on their capacities. For example, the terminal device 120 may select the PUCCH resource 520 that has a larger capacity than the PUCCH resource 510. It would be appreciated that the terminal device 120 may have more than two PUCCH resources for CSI report transmission overlap in time and thus may select the PUCCH resource with the largest capacity. The PUCCH resource with a high capacity can be used to convey information with a large payload size. In this sense, the multiple CSI reports on the selected uplink resource may have a smaller probability for being dropped.

In the embodiment as shown in FIGS. 6B and 6C, the terminal device 120 selects one of the PUCCH resources 510 and 520 based on their occasions. In the example of FIG. 6B, the terminal device 120 may select the PUCCH resource 510 because it is available in an earlier ending occasion, which will be helpful for reducing the latency of the multi-CSI transmission. In the example of FIG. 6C, the terminal device 120 may alternatively select the PUCCH resource 520 because it is available in a later starting occasion, which will be beneficial in the case where the terminal device 120 needs more time to prepare the CSI reports.

In the embodiment as shown in FIG. 6D, the terminal device 120 selects one of the PUCCH resources 510 and 520 based on their associated PUCCH formats. In some embodiments, it is configured that a predetermined format (a format X) is preferred to other formats. For example, a long PUCCH format is preferred than a short PUCCH format. Thus, if the PUCCH resource 520 is associated with the format X, the terminal device 120 may prefer this resource over the others. In some embodiments, the terminal device 120 may select one of the PUCCH resources 510 and 520 based on the priorities of their associated PUCCH formats. Thus, the PUCCH resource associated with a PUCCH format with a higher priority may then be selected.

In some embodiments, the terminal device 120 may have another type of UCI to be transmitted (for convenience of discussion, referred to as third UCI). The type of the third UCI may be different from the type of the first and second UCI. In some embodiments, the third UCI may be one or more SRs. A third uplink resource may be configured by the network device 110 for transmitting the third UCI. The PUCCH resource is configured for the SRs via higher layer signaling, for example, RRC signaling.

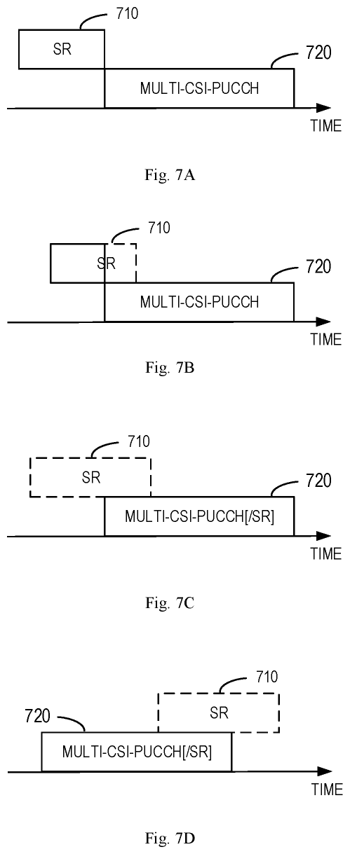

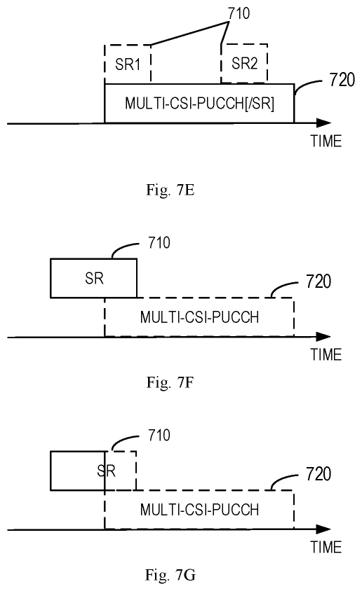

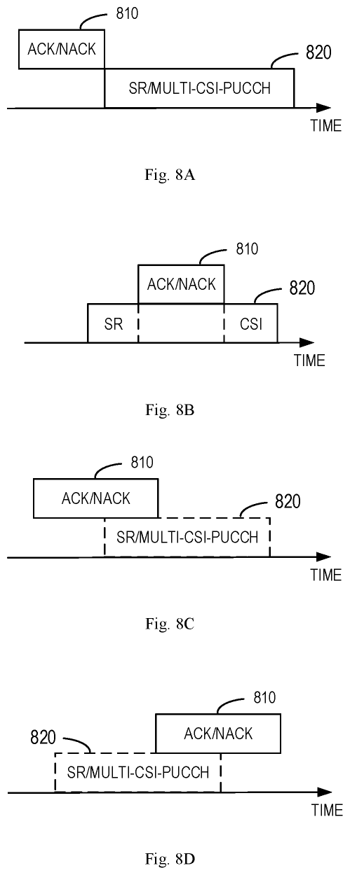

The SR transmission on the third uplink resource may be collided with the multi-CSI transmission on the selected uplink resource. The terminal device 120 may determine whether the third uplink resource overlaps with the selected uplink resource for the multiple CSI reports in time. Depending on the overlapping condition, the terminal device 120 may further determine how to transmit the CSI reports and the SR(s). Some examples of UCI transmission in the case of SR and multi-CSI report collision will be described with reference to FIGS. 7A and 7G. In these examples, a PUCCH resource 710 is configured by the network device 110 for transmitting one or more SRs, and a PUCCH resource 720 is determined by the terminal device 120 for transmitting the multiple CSI reports. The PUCCH resource 720 may be the one that is determined according to the embodiments as described with reference to any one of FIGS. 6A-6D.

In the example of FIG. 7A, the terminal device 120 determines that the PUCCH resource 710 is not overlapped with the PUCCH resource 720 in time. For example, the PUCCH resource 710 is adjacent to or spaced from the PUCCH resource 720. In this example, the terminal device 120 may transmit the UCI using the two PUCCH resources in a time division multiplexing (TDM) manner. Specifically, the terminal device 120 transmits the CSI reports using the PUCCH resource 720 and transmits the SR(s) using the PUCCH resource 710.

In the example of FIG. 7B, the terminal device 120 determines that the PUCCH resource 710 overlaps partially with the PUCCH resource 720 in time. As shown, a part of the PUCCH resource 710 overlaps with the PUCCH resource 720. In this example, the terminal device 120 may also transmit two PUCCH resources. Specifically, the terminal device 120 may transmit the CSI reports using the PUCCH resource 720 and transmits a portion of the SR using a remaining part of the PUCCH resource 710 that is not overlapped with the PUCCH resource 720. In this example and in the example of FIGS. 7A and 7B, the PUCCH resource 710 may be a short PUCCH resource.

In the examples of FIGS. 7C to 7E, the terminal device 120 determines that the PUCCH resource 710 and the PUCCH resource 720 partially overlap with each other (in FIGS. 7C and 7D) or fully overlaps with each other (in FIG. 7E). In these examples, the terminal device 120 may multiplex the different types of UCI and transmit the multiplexed UCI using one PUCCH resource. Specifically, the terminal device 120 may multiplex the SR(s) with the CSI reports to obtain multiplexed UCI and then transmit the multiplexed UCI using the PUCCH resource 720. This is because the PUCCH resource configured for the SR(s) may be smaller than the PUCCH resource configured for the CSI reports. However, it would be appreciated that in some other embodiments, the multiplexed UCI may also be transmitted using the PUCCH resource 710. In the examples of multiplexing, additional information (one or more bits) may be transmitted together with the multiplexed UCI, indicating the SR(s) multiplexed. For example, a bitmap of size n can be used in the UCI to indicate a number n of multiplexed SRs, and the bit “1”/“0” in the bitmap means a positive/negative SR for the corresponding multiplexed SR PUCCH.

In the examples of FIGS. 7F and 7G, the terminal device 120 determines that the PUCCH resources 710 and 720 overlaps with each other or adjacent with each other, the terminal device 120 may drop the CSI reports and transmit the SR(s) using the PUCCH resource 710 because the SR(s) may be more important than the CSI reports. More particularly, in the example of FIG. 7G where the PUCCH resource 710 and 720 are partially overlapped, the terminal device 120 may drop the CSI reports and a portion of the SR(s) and then transmit the remaining portion of the SR(s) using the remaining part of the PUCCH resource 710 that is not overlapped with the PUCCH resource 720.

In some embodiments, the terminal device 120 may have a further type of UCI to be transmitted (for convenience of discussion, referred to as fourth UCI). The type of the fourth UCI may be different from the types of the first, second, and third UCI. In some embodiments, the fourth UCI may be the ACK/NACK feedback. A fourth uplink resource may be configured by the network device 110 for transmitting the fourth UCI. The fourth PUCCH resource may be configured for the ACK/NACK feedback via DCI.

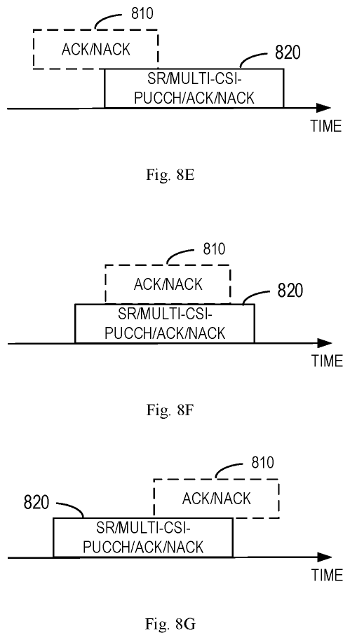

The ACK/NACK feedback transmission on the fourth uplink resource may be collided with the multi-CSI transmission on the selected uplink resource and probably with the SR transmission. The terminal device 120 may determine whether the fourth uplink resource overlaps with the selected uplink resource for the multiple CSI reports in time (and with the third uplink resource). Depending on the overlapping condition, the terminal device 120 may further determine how to transmit the ACK/NACK feedback, the CSI reports and probably the SR(s). Some examples of UCI transmission in the case of SR and multi-CSI report collision will be described with reference to FIGS. 8A and 8G. In these examples, a PUCCH resource 810 is configured by the network device 110 for transmitting the ACK/NACK feedback, and a PUCCH resource 820 is determined by the terminal device 120 for transmitting the multiple CSI reports and probably the SR(s). The PUCCH resource 820 may be the one that is determined according to the embodiments as described with reference to any one of FIGS. 7A-7G.

In the examples of FIG. 8A, the terminal device 120 determines that the PUCCH resource 810 is not overlapped with the PUCCH resource 820 in time. For example, the PUCCH resource 810 is adjacent to or spaced from the PUCCH resource 820. In this example, the terminal device 120 may transmit the different types of UCI using the two PUCCH resources in a TDM manner. Specifically, the terminal device 120 transmits the ACK/NACK feedback using the PUCCH resource 810 and transmits the CSI reports and/or SR(s) using the PUCCH resource 820.

In the example of FIG. 8B, the terminal device 120 determines that the PUCCH resource 810 overlaps partially or fully with the PUCCH resource 820 in time. As shown, a part of the PUCCH resource 810 fully overlaps with the PUCCH resource 820. In this example, the terminal device 120 may also transmit two PUCCH resources. Specifically, the terminal device 120 may transmit the ACK/NACK feedback using the PUCCH resource 810. The terminal device 120 may puncture the PUCCH resource 820 according to the overlapped size of the PUCCH resource 820 with the PUCCH resource 810 and then transmit the CSI reports and/or SR(s) using the punctured PUCCH resource 820. Specifically, the terminal device 120 may transmit the SR and/or CSI reports using the part of the PUCCH resource 820 that is not overlapped with the PUCCH resource 810. The example of puncturing can be applied with the overlapped size of the PUCCH resource 820 with the PUCCH resource 810 is limited (lower than a predetermined threshold).

In the examples of FIGS. 8C and 8D, if the terminal device 120 determines that the PUCCH resource 810 overlaps partially or fully with the PUCCH resource 820 in time and the overlapped part of the PUCCH resource 820 with the PUCCH resource 810 is large (for example, the length of the overlapped part is greater than a length threshold), the terminal device 120 may drop the CSI reports. In these examples, the PUCCH resources 810 and 820 may be fully or partially overlapped with each other. The terminal device 120 may then transmit the ACK/NACK feedback and the SR(s) using the PUCCH resource 810. The SR(s) and the ACK/NACK feedback may be multiplexed on the PUCCH resource 810.

In the examples of FIGS. 8E to 8G, the terminal device 120 determines that the PUCCH resources 810 and 820 are fully overlapped with each other (in FIGS. 8E and 8F) or partially overlapped with each other (in FIG. 8G). The terminal device 120 may multiplex the ACK/NACK feedback with the CSI reports (and probably the SR(s)) to obtain further multiplexed UCI. The terminal device 120 may then transmit the further multiplexed UCI using the PUCCH resource 820. In some other embodiments, the PUCCH resource 810 may be used to transmit the further multiplexed UCI.

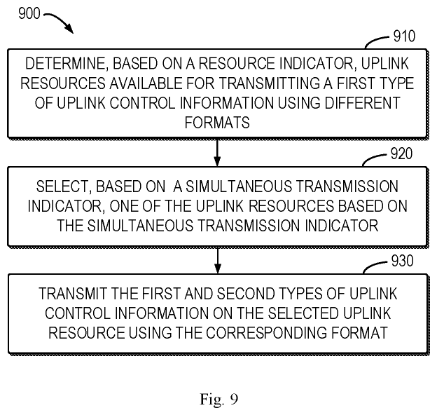

FIG. 9 shows a flowchart of an example method 900 in accordance with some embodiments of the present disclosure. The method 900 can be implemented at a terminal device 120 as shown in FIG. 1. For the purpose of discussion, the method 900 will be described from the perspective of the terminal device 120 with reference to FIG. 1.

At block 910, the terminal device 120 determines, based on a resource indicator from a network device 110, uplink resources available for transmitting a first type of uplink control information using different formats. At block 920, the terminal device 120 selects one of the PUCCCH resources based on a simultaneous transmission indicator from the network device 110, the simultaneous transmission indicator that simultaneous transmission of the first type and a second type of uplink control information is supported using at least one of the different formats. At block 930, the terminal device 120 transmits, to the network device 110, the first and second types of uplink control information on the selected uplink resource using the corresponding format.

In some embodiments, selecting one of the uplink resources further includes selecting one of the uplink resources further based on a total payload size of the first and second types of uplink control information.

In some embodiments, selecting one of the uplink resources further includes selecting one of the uplink resources further based on a coverage requirement for at least one of the first and second types of uplink control information.

In some embodiments, selecting one of the uplink resources further includes selecting one of the uplink resources further based on a latency requirement for at least one of the first and second types of uplink control information.

In some embodiments, selecting one of the uplink resources further includes in response to the simultaneous transmission indicator indicating that the simultaneous transmission is supported using at least two of the different formats, selecting one of the uplink resources based on predetermine priorities of the at least two formats.

In some embodiments, the simultaneous transmission indicator indicates that the simultaneous transmission is supported using one of the different formats.

In some embodiments, the first type of uplink control information includes a positive acknowledgement/negative acknowledgement (ACK/NACK) feedback and/or a scheduling request (SR), and the second type of uplink control information includes channel state information (CSI).

In some embodiments, the uplink resources include physical uplink control channel (PUCCH) resources.

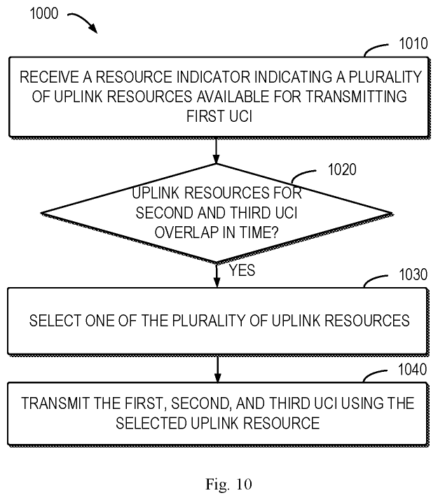

FIG. 10 shows a flowchart of an example method 1000 in accordance with some embodiments of the present disclosure. The method 1000 can be implemented at a terminal device 120 as shown in FIG. 1. For the purpose of discussion, the method 1000 will be described from the perspective of the terminal device 120 with reference to FIG. 1.

At block 1010, the terminal device 120 receives a resource indicator indicating a plurality of uplink resources available for transmitting first uplink control information, the first uplink control information being of a first type. At block 1020, the terminal device 120 determines whether a second uplink resource configured for transmitting second uplink control information and a third uplink resource configured for transmitting third uplink control information overlap in time, the second and third uplink control information being of a second type. At block 1030, in response to determining determines that the second and third uplink resource overlap in time, the terminal device 120 selects one of the plurality of uplink resources, the selected uplink resource supporting simultaneous transmission of the first and second types of uplink control information. At block 1040, the terminal device 120 transmits the first, second, and third uplink control information using the selected uplink resource.

In some embodiments, selecting one of the plurality of uplink resources includes receiving, from the network device, a simultaneous transmission indicator indicating that the simultaneous transmission is supported by one of the plurality of uplink resources; and selecting the uplink resource that supports the simultaneous transmission.

In some embodiments, the uplink resources include physical uplink control channel (PUCCH) resources.

In some embodiments, the first type of uplink control information includes a positive acknowledgement/negative acknowledgement (ACK/NACK) feedback and/or a scheduling request (SR), and the second type of uplink control information includes channel state information (CSI).

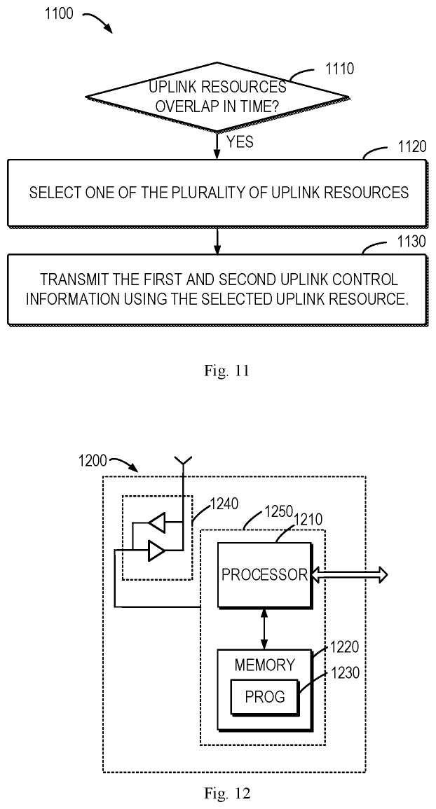

FIG. 11 shows a flowchart of an example method 1100 in accordance with some embodiments of the present disclosure. The method 1100 can be implemented at a terminal device 120 as shown in FIG. 1. For the purpose of discussion, the method 1100 will be described from the perspective of the terminal device 120 with reference to FIG. 1.

At block 1110, the terminal device 120 determines whether a first uplink resource configured for transmitting first uplink control information and a second uplink resource configured for transmitting second uplink control information overlaps in time. At block 1120, in response to determining that the first and second uplink resource overlaps in time, the terminal device 120 selects one of the first and second uplink resources based on at least one of capacities of the first and second uplink resources, occasions of the first and second uplink resources, formats supported by the first and second uplink resources. At block 1030, the terminal device 120 transmits the first and second uplink control information using the selected uplink resource.

In some embodiments, selecting one of the first and second uplink resources includes selecting one of the first and second uplink resources that has a larger capacity, an earlier ending occasion or a later starting occasion, and/or a predetermined format.

In some embodiments, transmitting the first and second uplink control information includes in response to determining that a third uplink resource is configured for transmitting third uplink control information, determining whether the third uplink resource overlaps with the selected uplink resource in time; and in response to determining that the third uplink resource is adjacent to or spaced from the selected uplink resource in time, transmitting the first and second uplink control information using the selected uplink resource and the third uplink control information using the third uplink resource.

In some embodiments, transmitting the first and second uplink control information further includes: in response to determining that a part of the third uplink resource overlaps with the selected uplink resource, transmitting the first and second uplink control information using the selected uplink resource and a portion of the third uplink control information using a remaining part of the third uplink resource.

In some embodiments, transmitting the first and second uplink control information further includes: in response to determining that the third uplink resource overlaps with the selected uplink resource, multiplexing the third uplink control information with the first and second uplink control information to obtain multiplexed uplink control information; and transmitting the multiplexed uplink control information using the selected uplink resource.

In some embodiments, transmitting the multiplexed uplink control information includes: transmitting the multiplexed uplink control information and additional information to indicate the third uplink control information.

In some embodiments, the method 1100 include in response to determining that the third uplink resource overlaps with the selected uplink resource, dropping the first and second uplink control information; and transmitting the third uplink control information using the third uplink resource.

In some embodiments, transmitting the third uplink control information: in response to determining that a part of the third uplink resource overlaps with the selected uplink resource, dropping a portion of the third uplink control information; and transmitting a remaining portion of the third uplink control information using a remaining part of the third uplink resource.

In some embodiments, the first and second uplink control information include different channel state information (CSI), and the third uplink control information includes a scheduling request (SR); and the first, second, and third uplink resources are configured via radio resource control (RRC) signaling.

In some embodiments, transmitting the multiplexed uplink control information includes: in response to determining that a fourth uplink resource is configured for transmitting fourth uplink control information, determining whether the fourth uplink resource overlaps with the selected uplink resource in time; and in response to determining that the fourth uplink resource is adjacent to or spaced from the selected uplink resource in time, transmitting the multiplexed uplink control information using the selected uplink resource and the fourth uplink control information using the fourth uplink resource.

In some embodiments, transmitting the multiplexed uplink control information further includes: in response to determining that a part of the selected uplink resource overlaps with the fourth uplink resource, transmitting the multiplexed uplink control information using a remaining part of the selected uplink resource and the fourth uplink control information using the fourth uplink resource.

In some embodiments, transmitting the multiplexed uplink control information further includes: in response to determining that the selected uplink resource overlaps with the fourth uplink resource, determining whether a length of a part of the selected uplink resource overlapped with the fourth uplink resource is greater than a length threshold; in response to determining that the length is greater than the length threshold, dropping the first and second uplink control information; and transmitting the third and fourth uplink control information using the fourth uplink resource.

In some embodiments, transmitting the multiplexed uplink control information further includes: in response to determining that the selected uplink resource overlaps with the fourth uplink resource, multiplexing the fourth uplink control information with the multiplexed uplink control information to obtain further multiplexed uplink control information; and transmitting the further multiplexed uplink control information using the selected uplink resource.

In some embodiments, the fourth uplink control information includes positive acknowledgement/negative acknowledgement (ACK/NACK) feedback.

In some embodiments, the fourth uplink resource is configured via downlink control information (DCI).

In some embodiments, the first and second uplink resource include physical uplink control channel (PUCCH) resources.

It is to be understood that all operations and features related to the network device 110 and terminal device 120 described above with reference to FIGS. 2-8G are likewise applicable to the methods 900-1100 and have similar effects. For the purpose of simplification, the details will be omitted.

FIG. 12 is a simplified block diagram of a device 1200 that is suitable for implementing embodiments of the present disclosure. The device 1200 can be considered as a further example implementation of a network device 110 or a terminal device 120 as shown in FIG. 1. Accordingly, the device 1200 can be implemented at or as at least a part of the network device 110 or the terminal device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 2 to 4 and FIGS. 9 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1210 may form processing means 1250 adapted to implement various embodiments of the present disclosure.

The memory 1210 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1210 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 6D. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31. A method of a terminal device, the method comprising:
receiving from a base station, in an RRC (Radio Resource Control) signalling, information indicating a first PUCCH (Physical Uplink Control Channel) resource for a first CSI (Channel State Information) report and a second PUCCH resource for a second CSI report;
determining that the first PUCCH resource and the second PUCCH resource overlap; and
multiplexing the first CSI report and the second CSI report in a third PUCCH resource.

32. The method of claim 31, further comprising: transmitting the first CSI report and the second CSI report multiplexed in the third PUCCH resource to the base station.

33. The method of claim 31, wherein the terminal device further multiplexes HARQ-ACK (Hybrid Automatic Repeat Request-Acknowledgement) information with the first CSI report and the second CSI report in the third PUCCH resource.

34. The method of claim 31, wherein the third PUCCH resource is equivalent to either the first PUCCH resource or the second PUCCH resource.

35. The method of claim 31, further comprising:
receiving information indicating the third PUCCH resource.

36. A method of a base station, the method comprising:
sending to a terminal device in an RRC (Radio Resource Control) signalling, information indicating a first PUCCH (Physical Uplink Control Channel) resource for a first CSI (Channel State Information) report and a second PUCCH resource for a second CSI report;
in response to the terminal determining that the first PUCCH resource and the second PUCCH resource overlap, receiving the first CSI report and the second CSI report multiplexed in a third PUCCH resource.

37. The method of claim 36, wherein the base station further receives HARQ-ACK (Hybrid Automatic Repeat Request-Acknowledgement) information multiplexed with the first CSI report and the second CSI report in the third PUCCH resource.

38. The method of claim 36, wherein the third PUCCH resource is equivalent to either the first PUCCH resource or the second PUCCH resource.

39. The method of claim 36, further comprising:
sending information indicating the third PUCCH resource.

40. A terminal device comprising:
a receiver configured to receive from a base station, in an RRC (Radio Resource Control) signalling, information indicating a first PUCCH (Physical Uplink Control Channel) resource for a first CSI (Channel State Information) report and a second PUCCH resource for a second CSI report;
a controller configured to: determine that the first PUCCH resource and the second PUCCH resource overlap; and multiplex the first CSI report and the second CSI report in a third PUCCH resource.

41. The terminal device of claim 40, further comprising a transmitter configured to transmit the first CSI report and the second CSI report multiplexed in the third PUCCH resource.

42. The terminal device of claim 40, wherein the controller is further configured to multiplex HARQ-ACK (Hybrid Automatic Repeat Request-Acknowledgement) information with the first CSI report and the second CSI report in the third PUCCH resource.

43. The terminal device of claim 40, wherein the third PUCCH resource is equivalent to either the first PUCCH resource or the second PUCCH resource.

44. The terminal device of claim 40, wherein the receiver is further configured to receive information indicating the third PUCCH resource.
